(19) United States
(12) Patent Application Publication
(10) Pub. No.: US 2008/0177748 A1
(43) Pub. Date: Jul. 24, 2008

(54) SQL Faceplate

(76) Inventor: Christopher Rondot, Quebec City (CA)

Correspondence Address: Christopher Rondot, 6368 Ave Royale, LAnge Gardien, QC, G0A2K0, omitted

(21) Appl. No.: 11/626,830

(22) Filed: Jan. 24, 2007

(51) Int. Cl. G06F 17/30

(52) U.S. Cl. 707/10; 707/E17.032

(57) ABSTRACT

Structured query language server data sources often times have different language constructs for interacting with software data consuming clients. A unified structured query language data server is interposed in the network chain between the structured query language server data sources and the networked data consuming software clients to present an interface to retrieve networked data from different SQL database server types in one single structured query language to software consumers in the form of computer programs accessing the data on a network. These data consuming clients can now access any number of SQL database sources with one single set of structured query language commands through the invention which acts as a query language translating device, though not exclusively. The invention also provides a unified authentication method to access data in structured query language server data sources connected to it. Data consuming software clients can also use the invention to collate several requests from same or different types of structured query language data servers into one single structured data response based on a set of requests using one structured query language based on the ISO/ANSI SQL standard.

### BACKGROUND OF THE INVENTION

Data has been managed by servers with a structured query language interface since the 1970s with development of such systems by IBM and other companies. Various companies however have made small adjustments in a structured query language for data retrieval, and these small differences make it extremely difficult for software to query different structured query language servers in a transparent and unified way. These servers have traditionally been available through networked connections across Intra nets and the Internet often times providing a secure data exchange and retrieval mechanism. The problem with this is that application programmers must create new connections to each of the different structured query language servers and use different language constructs and methods for each piece of data they need, and weave them together in a sort of collage of data to produce reports, graphs, and other data presentation layers. Solutions such as open database connectivity application programming interfaces to connect to different database management systems have existed for quite some time, but they do not let applications connect to a centralized structured query language server and transparently request data as a single set of structured query language requests as the invention does. The invention also solves the problem of weaving data retrieved from disparate structured query language data sources by collating these proxied requests into a single response set, further sorting the responses from the end point structured query language data servers based on optional structured query language instructions requesting that operation from the consuming client software. In contrast, ODBC drivers and data access models depend on computer binary code integration as an application programming interface, where as the invention is a stand alone network server solution which accepts structured query language instructions to generate responses from disparate structured query language server data sources on networks potentially unknown to the data requesting computer application. ODBC and many prior data access schemes require explicit and separate authentication with the data sources the client program is connected to. The invention optionally allows for a unified authentication to allow the client data consuming software program to optionally authenticate against several disparate structured query language server data sources with a trusted single login.

The invention optionally collates the data fetched from structured query language server end points in a way defined by structured query language instructions sent from the computer software consumer. Structured query language (SQL) has been standardized by ANSI/ISO.

### SUMMARY OF THE INVENTION

This invention resolves many different structured query language server requests and data exchanges into one unified software server hub that networked computer software applications can connect to and retrieve data from in a unified way, with one single set of structured query language instructions. The invention sits between the software data consumer application and the structured query language servers logically behind it. The invention acts as a request manager, which manages requests between the software data consumer which may not know which specific structured query language the end point servers which contain the data the requesting software wants, and the SQL servers. The software data consumer may specify a specific structured query language server end point to the invention or it may simply request the data, which the invention in turn requests from structured query language server end points by a default configuration manifest. The invention itself is a networked structured query language server which takes structured query language instructions as a request to produce a response containing data the software application consumer requested. It can be used in an intranet, wide area network, local area network, Internet and networked computer environments. The invention offers an authentication method allowing connecting client software programs to have access to certain parts or all of the data on all structured query language servers connected to it. The invention is a SQL faceplate allowing client software consumers to access data from many different SQL sources using the invention as an interpreter and enhancer.

### BRIEF DESCRIPTION OF THE DRAWINGS

FIG. 1 is a block diagram depicting the components of one embodiment of the present invention.

FIG. 2 is a flow diagram describing the initial response after a connection to the invention by a computer client.

FIG. 3 is a block diagram depicting the information being sent back to the connecting client computer in more detail.

FIG. 4 is a flow diagram depicting the way information is requested and returned to a client computer.

FIG. 5 is a block diagram depicting a view of part of the invention's basic modular components.

FIG. 6 is a flow diagram depicting a more detailed view of the invention's processing cycle and code components between clients, and connected servers.

FIG. 7 is a partial flow diagram depicting a more detailed view of the invention's identity management and data access system

### DETAILED DESCRIPTION

### Functional Synopsis

The invention is useful in providing a data access layer to computer software applications with a single structured instruction interface to access data in several unrelated structured query language data server sources. These structured query language data servers regularly serve data and information typically stored on computer hard disks, flash media, magnetic tape, and optical media such as cds, dvds, and high definition dvds. The structured query language data servers from various vendors use different language features and lexicons which make them challenging to use from the perspective of the software client application code, which must use different structured query language instruction sets to retrieve data from each structured query language data server it wishes to include in it's computer program. The invention creates a single structured query language data server that software applications can connect to and request data, which is taken from any number of structured query language data server end points on a network from any number of unrelated software vendors potentially running a variety of different structured query language instruction sets to retrieve data in a unified way. The invention takes requests in a single structured query language instruction set, and manages network connection to the structured query language data server end points, optionally using non-standard SQL instructions that the software application consumer sends it to point to the correct structured query language data server end point from which the original software application consumer intended the data to come from. If no end point SQL server is specified, default data retrieval from the consumer software application to the end point structured query language data servers is performed by the invention based on an administrator configured manifest of default configuration instructions. These non-standard SQL instructions such as ATSERVER, which are sent to the invention contain information about which endpoint structured query language data server the software application consumer wishes the data to come from.

The invention allows connecting client software programs to have access to some or all of the data on all structured query language servers connected to it based on authenticated privilege levels. This functionality is administrator defined and can be modified in a configuration manifest. The invention also optionally accepts additional structured query language instructions to collate the requests from different structured query language data server end points into a single set of data as a response to send back to the software application consumer.

### Definitions:

computer—An electronic device for the storage and processing of information.
SQL—SQL (Structured Query Language) is a standard interactive and programming language for getting information from and updating a database.
network—A wide variety of systems of interconnected computers.
interface—a connection between hardware devices, applications, or different sections of a computer network.
application—programs that reside and run on some computer
software—Written coded commands that tell a computer what tasks to perform.
server—A computer that delivers information and software to other computers linked by a network.
TCP/IP—Transmission Control Protocol/Internet Protocol A protocol for communication between computers, used as a standard for transmitting data over networks and as the basis for standard Internet protocols.
data—Information stored on the computer system, used by applications to accomplish tasks.
database—A database is an organized collection of information records that can be accessed electronically.
request—A message sent from a client computer to a server computer requesting information.
response—A message sent from a server computer to a client computer providing information.
SQL read and write privileges—a short form of saying all privileges related to SQL queries including but not limited to SELECT, INSERT, UPDATE, DELETE, FILE, Structure, CREATE, ALTER, INDEX, DROP, CREATE TEMPORARY TABLES, CREATE VIEW, SHOWVIEW, CREATE ROUTINE, ALTER ROUTINE, EXECUTE, Administration, GRANT, SUPER, PROCESS, RELOAD, SHUTDOWN, SHOW DATABASES, LOCK TABLES, REFERENCES, REPLICATION CLIENT, REPLICATION SLAVE, CREATE USER, in either a read manner or a write manner.
read manner—reading data from a database or server.
write manner—writing data to a database or server.

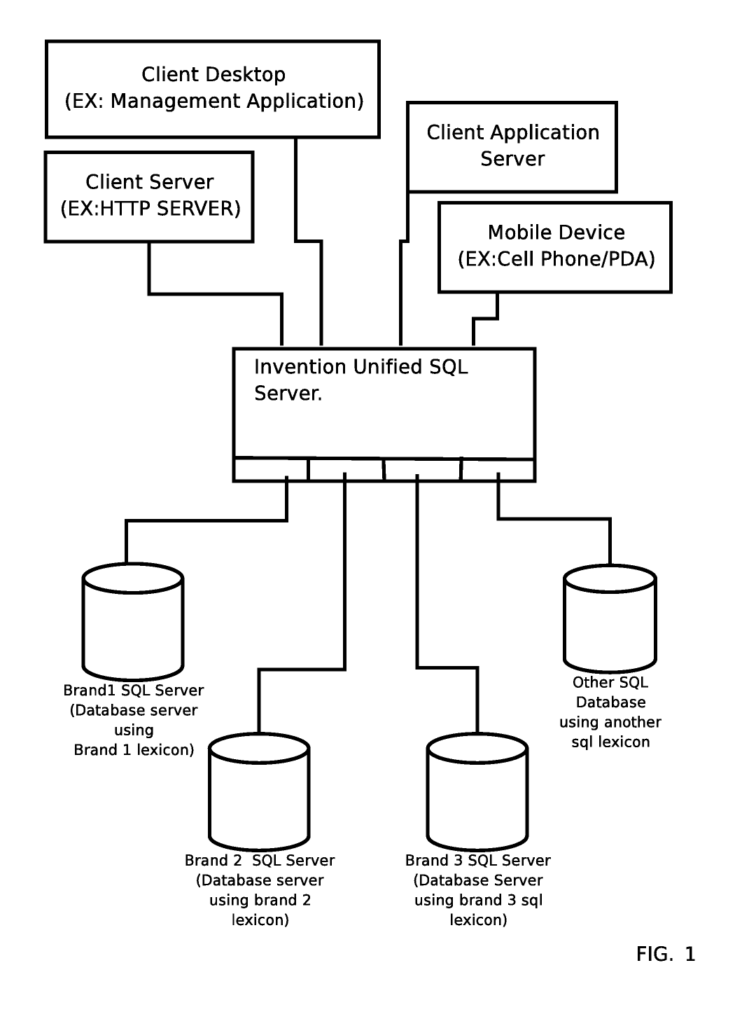

FIG. 1 depicts the conceptual operation of the clients as application servers, web servers, personal computers, or mobile devices fetching data from various different types of structured query data servers.

FIG. 1 depicts the structured query language servers connected to the invention as software servers of different types of brands and with different structured query language lexicons.

Specifically, FIG. 1 depicts the client software applications running on computers connected to the invention requesting and receiving data based on structured query language requests aimed at the invention, and the invention filling those requests from data located in structured query language servers of different brands and types connected to it.

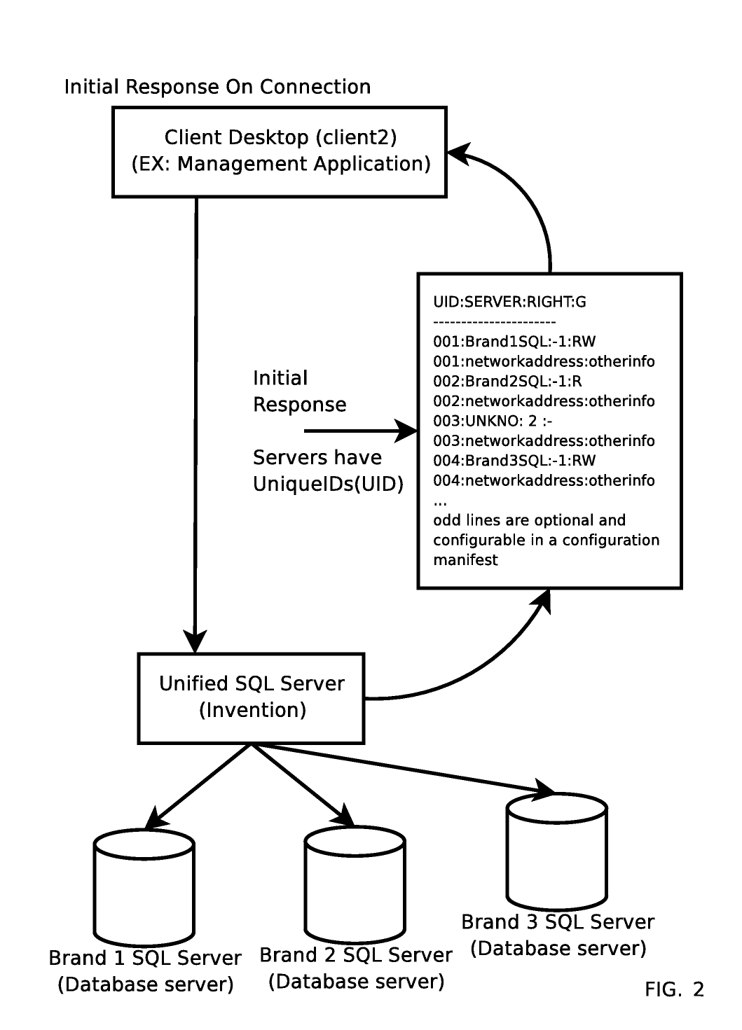

FIG. 2 depicts the initial response from the invention to the network connected software client. This response includes information about structured query language (SQL) software database servers connected to it, including unique ids for referencing those servers by the client applications directly, and also shows the optional response information such as the network address of those connected SQL servers on odd lines. The odd line information is configurable via a manifest of configuration directives. The initial response also shows SQL read and write privileges on the SQL databases connected to the invention sent in the response based on the software authentication level when it logged in. The read and write privilege data sent in the response is also optional and configurable via a configuration manifest.

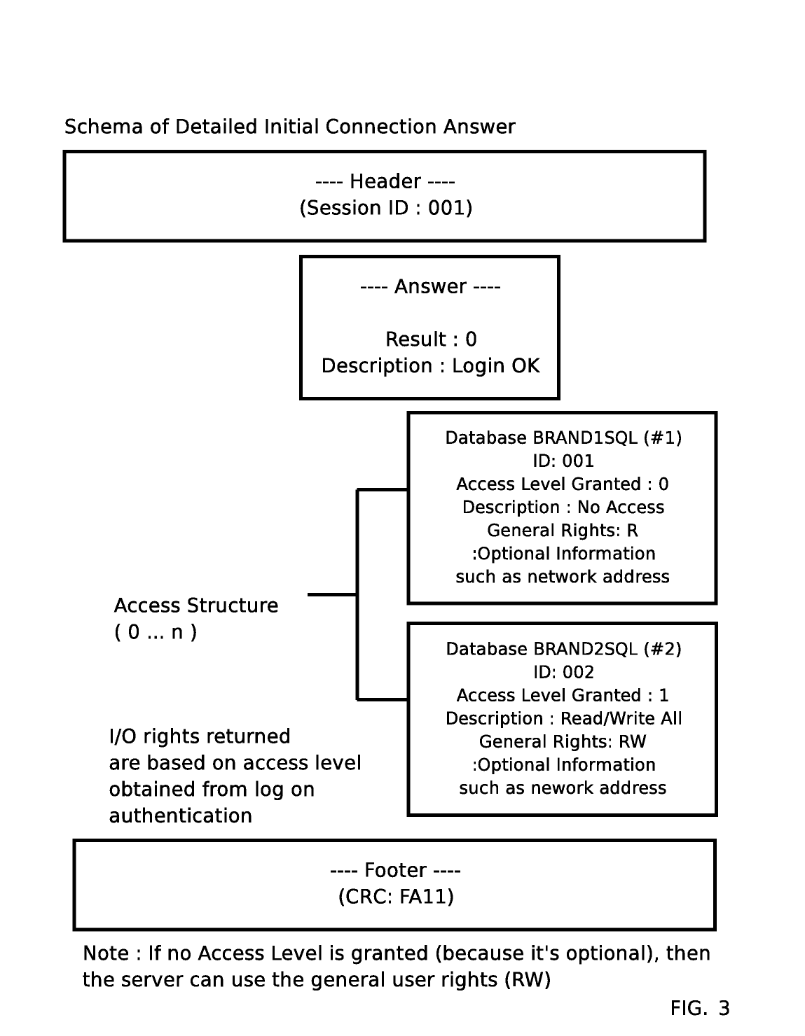

FIG. 3 depicts a more detailed view of the initial connection answer. More specifically, when a client software application connects to the invention via a network connection, for example a TCP/IP connection via an intranet or Internet, the invention returns a list of available SQL resources, namely the connected SQL software database servers, as determined by the privilege level of the user determined from the initial authentication.

FIG. 3 depicts the initial response from the invention based on a network connection and authentication handshake request from a software client connecting to the invention for the first time. Each time the network connection to the invention is broken, the client must repeat this process on reconnect.

Specifically, FIG. 3 shows the invention returning information about software database servers connected to it as part of an access structure determined by a client identification management and software client rights system.

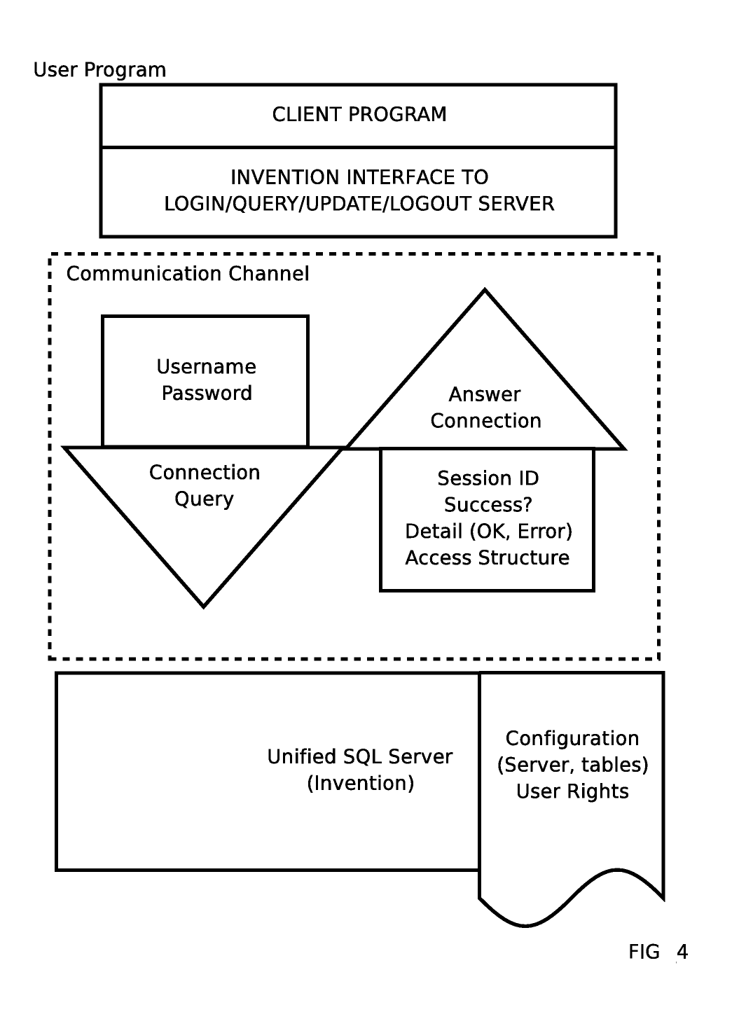

FIG. 4. depicts a general overview of the invention consulting a configuration manifest in order to determine the rights of each connected software application client as it processes requests for data, and returns data from SQL database software servers connected to it based on those rights and the access level of the software data consuming client.

FIG. 4 depicts an interface on the software application client to connect to the invention. It depicts a software mechanism on the client application which allows it to communicate with the invention across a network connection. The invention interface it depicts on the client application is not limited to software using a SQL driver library. The interface can be accessed by something as simple as telnet or raw network data socket transfer. This is because the invention accepts basic plain text structured query language commands and is not an binary API or application programming interface.

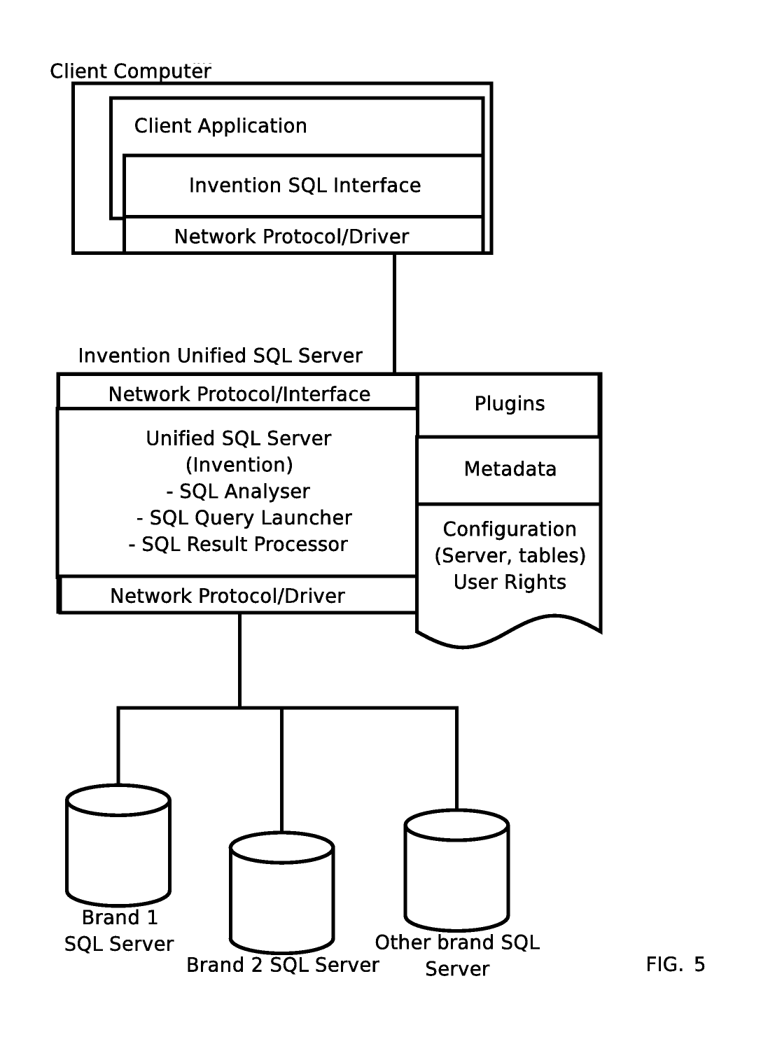

FIG. 5 depicts a general overview of the way the invention takes structured query language commands, then interprets and reprocesses them in a way that will be appropriate for the target structured query language server which contains the data the software application consumer requested from the invention.

FIG. 5 depicts the invention consulting plug ins, meta data, and configuration manifests to produce it's response to the software application consumer requesting data via a structured query language query or queries.

FIG. 5 depicts the invention connected to both software clients and structured query language servers via a network connection of an unspecified type. As an example, this connection could be a TCP/IP connection on an intranet or Internet.

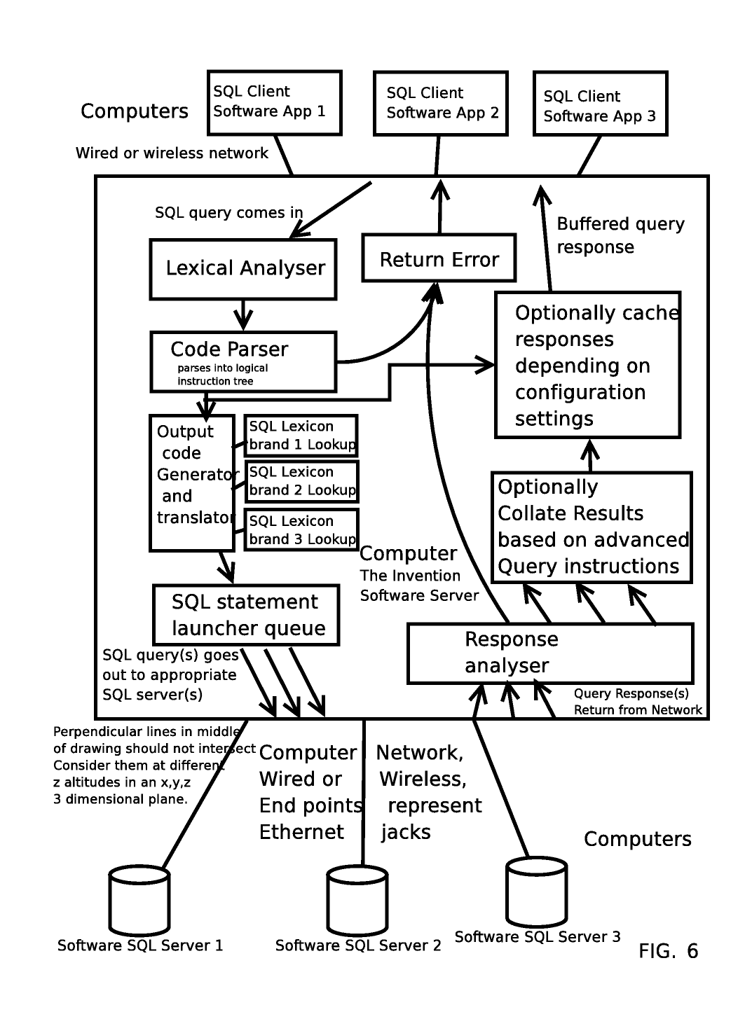

FIG. 6 depicts a more detailed view of the request.
FIG. 6 will now be referred to as “It”.
1A. It depicts SQL queries being sent from any number of software application clients via a network to the invention.
For example, but not limited to; “SELECT data FROM database WHERE condition;”
The instructions the client sends in a data query can be based on the SQL ANSI/ISO standard, but are not necessarily confined to those standards. Additional SQL instructions are optionally sent by the client to the invention in a query to perform advanced functions such as collating responses from multiple SQL servers connected to the invention described in the description of FIG. 6.3B below. Additional SQL instructions are optionally sent by the client to the invention in a query to specify which end point SQL server the client wishes to retrieve the data from.
2A. It depicts a lexical analyzer checking the data request query or queries for errors
3A. It depicts a code parser separating the code into tokens which are put into a logical tree of SQL instructions.
4A. It depicts an error return mechanism to feed back non-qualifying data requests to the application consumer.
5A. It depicts a code compiler that takes the logical instructions created by the parser and re-interprets them into statements that are understandable by the SQL server(s) it will get the response data from, based table lookups for different structured query language lexicons.
6A. It depicts a structured query language launcher queue where requests compiled by the SQL code compiler can be stacked and sent out as SQL requests to servers based on settings in a configuration manifest such as allowing multiple connections to a single end point SQL server or sending all requests sequentially to save computer processing resources for other applications running on the same computer as the invention.

FIG. 6 depicts the invention sending compiled SQL language data requests to SQL servers connected to it and receiving networked responses from those servers where the invention had initially connected to that SQL server with either with a persistent or dynamic network connection prior to the sending the query request(s).

FIG. 6 depicts a more detailed view of the response.
FIG. 6 will continue to be referred to as “It”.
1B. It depicts a SQL response(s) being received from a network connection to one or more of the SQL servers connected to the invention where the invention had sent a SQL query for data to that server prior to the response.
2B. It depicts an immediate logical error return to the software application that originally requested the data if the SQL server should not provide the expected result or should return an error message in the network response.
3B. It depicts a logical code module that can be invoked in the logical response chain to collate multiple structured data responses from one or more SQL server responses into a single data response, based on additional non-standardized SQL commands sent to the invention at the time of or prior to the data request.
4B. It depicts a logical code module that can be invoked in the logical response chain to save SQL data responses in the computer memory or on the hard disk or other writable media attached to the computer that hosts the invention, what is commonly referred to as caching, in order to immediately respond to a request should the same request be sent by the same or other software application clients requesting data from the invention. The cached data can be in a persistent storage state, or in a temporary state based on configuration options set by the administrator of the invention.
5B. It depicts an buffered query response, meaning a queue of responses sent out in an ordered way, to the requesting software application client, fulfilling the original request for the data from the requesting software application.
6B. It depicts perpendicular lines that seem to intersect in the middle of the drawing, but in fact do not, as they are not related to one another. There is an invisible bridge at the convergence of the intersecting lines. The line from the code parser's output goes under the bridge while the output from the response analyzer goes over the bridge at different altitudes.

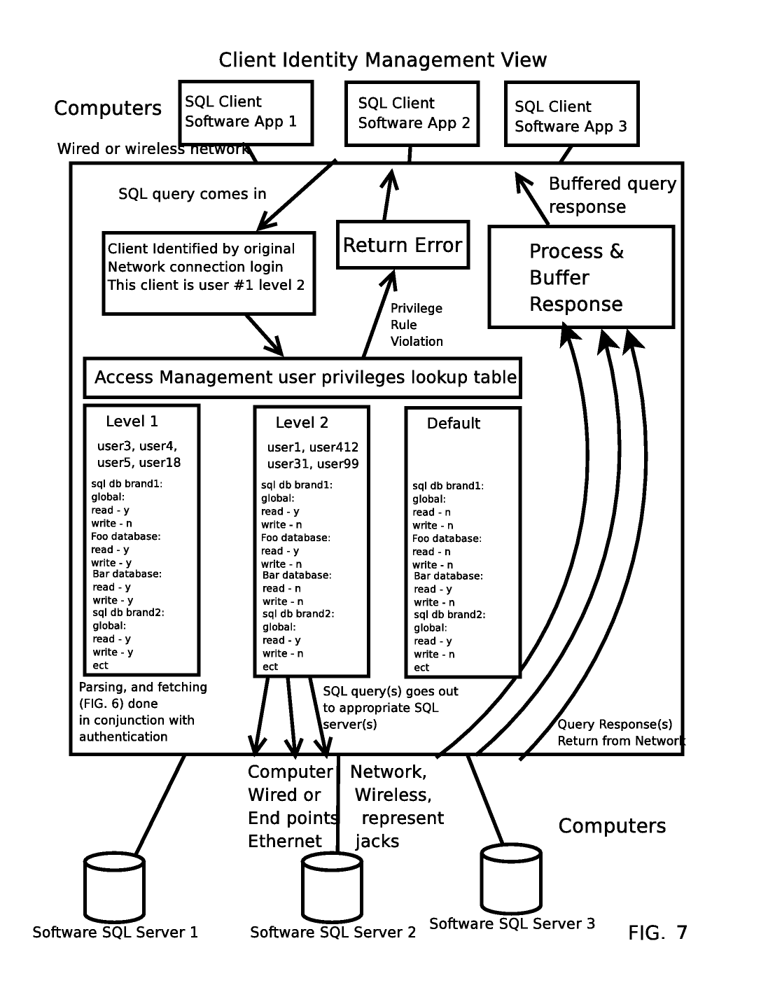

FIG. 7 depicts a more detailed view of the authentication system and mechanism.
FIG. 7 will now to be referred to as “It”.
1. It depicts a computer software client sending a network request for data as a SQL statement(s) to the invention
2. It depicts the invention server determining the access level of the software client requesting the data based on it's authentication upon connection to the invention server or another privilege request by the client to the invention.
3. It depicts a further grain of detail with the invention using a lookup table of possible access level structures and determining which one matches the authenticated user ID of the client which requested the data.
4. It depicts a table of privileges that match a client requesting data from the invention, including SQL read and write privileges for individual SQL servers connected to the invention as well as SQL read and write privileges on databases and tables within those individual SQL servers connected to the invention.
5. It depicts a default configuration for SQL read and write privileges for SQL servers connected to it, and their databases for clients which do not match a specific access level but have authenticated.
6. It depicts the invention returning an error message if authentication level is not sufficient to carry out the request the software client application sent the invention for data.
7. It depicts the response from the SQL servers connected to the invention being buffered and sent back to the requesting client software application from the invention.

What is claimed is:

1. Data consumers in the form of computer programs accessing data on a network are presented a single structured query language interface for accessing data from many different networked data sources that use different types of structured querying languages. Such is a system comprising of a middle tier structured query language translating networked server with additional collating and computing functionality based on client requests comprised of structured query language instructions over a computer network. SQL data access for software clients using a single set of SQL instructions for requesting data from various structured query language database servers, using same or varying SQL language lexicons, by using one SQL lexicon set and one network connection to the invention server is the basis of the invention.

2. The article of claim 1 wherein said response conditionally includes configuration information about the structured query language data servers from which the invention is presently connected.

3. The article of claim 1 wherein said candidate the server is a computer program acting as a structured query language translator.

4. The article of claim 1 wherein said candidate the server is a computer program acting as a structured query language server privilege and data access manager.

5. The article of claim 1 wherein said candidate the server is a computer program providing an optional unified authentication method for accessing structured query language server data sources connected to it.

6. The article of claim 1 wherein said candidate the server acts as middle ware to connect programs requesting data to structured query language data servers using same or varying types of structured query languages.

7. The article of claim 3 wherein said candidate uses a set of structured query language instructions to collate a single response based on multiple requests for data from the same or different structured query language server end points by the consumer application to the invention.

8. The article of claim 3 wherein said candidate optionally uses a set of non-standardized structured query language instructions to determine which end structured query language data server source the request was intended to retrieve the requested data from by way of the invention.

9. The article of claim 5 wherein said candidate will manage trusted authenticated logins to access either all or parts the data of all the structured query language servers connected to it.

10. The article of claim 6 wherein said candidate interprets a single set of structured query language instructions sent to it via network connected computer requests to access data from structured query language data server sources connected to the invention via a network.

11. The article of claim 7 wherein said candidate fetches the data as multiple structured query language requests from same types or different types of structured query language data servers based on a structured query language request(s) by a software application to the invention and sorts them based on a set of structured query language instructions aimed at unifying data sets from different structured query language data server end points as one single response.

12. The article of claim 8 wherein said candidate uses a configuration manifest to determine default connection properties when a structured query language data source end point was not explicitly specified by the structured query language data consumer.

13. The article of claim 9 wherein said candidate will choose what access level to the underlying structured query language server data sources to provide to which connected clients based on an administrator defined configuration manifest.

14. The article of claim 10 wherein said candidate uses a table of language constructs to reinterpret the structured query language data request and use it to retrieve the requested data from a specified data server source.
